(19) United States
(12) Patent Application Publication
(10) Pub. No.: US 2002/0116337 A1
(43) Pub. Date: Aug. 22, 2002

(54) System for anonymous distribution and delivery of digital goods

(76) Inventors: Ariel Peled, Even-Yehuda (IL); Lidror Troyansky, Ramat-Gan (IL); Ofir Carny, Kochav-Yair (IL)

Correspondence Address: DANIEL J SWIRSKY, PO BOX 2345, BEIT SHEMESH, 99544, IL

(21) Appl. No.: 10/078,000

(22) Filed: Feb. 20, 2002

Related U.S. Application Data
(60) Provisional application No. 60/269,387, filed on Feb. 20, 2001.

(51) Int. Cl. G06F 17/60; H04K 1/00; H04L 9/00

(52) U.S. Cl. 705/51; 705/26; 705/67; 705/39; 705/74

(57) ABSTRACT

A method for making an anonymous computerized commerce transaction involving the delivery of digital merchandise including the steps of sending first sensitive information from a first entity to a first intermediate entity, processing the first sensitive information at the first intermediate entity, creating first non-sensitive information operable to approve the transaction by the first intermediate entity, sending the first non-sensitive information to a third entity operable to perform the transaction, performing the transaction at the third entity, and transferring the digital merchandise to the first entity via a delivering entity including information operable to deliver the digital merchandise to the first entity without revealing the first sensitive information to the third entity.

### CROSS-REFERENCE TO RELATED APPLICATIONS

This application is related to and claims priority from U.S. Provisional Patent Application No. 60/269,387, filed Feb. 20, 2001, the contents of which are hereby incorporated herein by reference in their entirety.

### FIELD OF THE INVENTION

The present invention relates generally to the field of electronic or computerized commerce systems. Specifically, the present invention deals with anonymous transactions between a customer and a vendor.

### BACKGROUND OF THE INVENTION

Systems for the purchase, usage, distribution and monitoring of digital content over the Internet have existed for some time. The majority of these systems are aimed at supplying consumers with the ability to shop for digital content on-line. The systems are usually designed in client-server methodology; hence, a consumer uses client software to engage in a buying session with the server, which later shall deliver the content to the consumer. The most common payment method is based on credit cards, and therefore requires the personal details of the consumer. In this case, the client-server interaction is also used to transfer the consumer details needed for the monetary transaction, such as name, billing address, mailing address, credit card number, telephone numbers, social security ID number and more. Those personal details are stored in the server's database for billing and customer care.

Such method risk the consumers privacy, since:

1) The high number of such systems increases the likelihood that individuals may gain illegal and /or unauthorized access to at least one of these systems and make harmful and /or undesirable use of the information.

2) System users can track the preferences of their individual clients.

Methods for anonymous purchases using computer networks exist. Some of these methods are based on pre-paid, “digital cash”. Those methods are, in general cumbersome and have not acquired much popularity. Methods that provide anonymous payments using credit cards also exist. In general, these methods are based on separating the order information (OI) from the payment instruction (PI), by introducing another entity, generally referred to as “acquirer”, that guarantees, from behalf of the user, that the payment instruction are indeed valid without revealing the actual details of the user, so that the payment protocol provides the vendor only the order information such as the purchased items and their respective sales price, and the acquirer only with the credit-card information, so that the vendor is not required to have an access to the customer's credit card information, as long as the acquirer authorizes the purchase. This separation is achieved using either cryptographic methods or by deploying at least two paths (customer-vendor for order information, customer-acquirer for payment information and acquirer-vendor for authorization information). E.g., U.S. Pat. No. 5,420,926 describes a method for anonymous credit card transactions. The techniques include the use of a communications exchange so that information and funds may be transferred without the destination for the transfer knowing the source of the information or funds and the use of public key encryption so that each party to the transaction and the communications exchange can read only the information the party or the exchange needs for its role in the transaction. U.S. Pat. No. 6,119,101 describes a system for electronic commerce having personal agents that conceal the identity of the consumer. U.S. Pat. No. 6,108,644 describes a system and method for electronic transactions, including registration, audit and trusted recovery features, whereas transaction request message is received from a registered user that includes an unblinded validated certificate, and a blinded unvalidated certificate. If the unblinded validated certificate is determined to be legitimate, then a transaction can be performed, and the blinded unvalidated certificate is validated to obtain a blinded, validated certificate that is sent to the user.

While these methods provide an adequate level of anonymity in the buying phase, there is still a need to establish an initial connection between the client and the vendor, and the digital and/or physical goods need to be sent, eventually, to the customer by the vendor. Using current methods usually requires that in order to create this connection, both parties to the connection disclose information regarding their identity. Thus, current methods do not provide an adequate level of anonymity in these phases, and unauthorized individuals or organization taking advantage of the pitfalls of current methods may violate the anonymity of consumers.

### SUMMARY OF THE INVENTION

The present invention seeks to provide a novel method to facilitate fully anonymous purchases. Specifically, the current invention provides methods that allow anonymous distribution and delivery of digital and/or physical entities, thereby allowing the buyer to remain anonymous throughout the entire buying process.

In a preferred embodiment of the present invention the anonymization method utilizes an anonymous initial connection between the vendor and the client and an anonymous distribution and delivery route, based on a chain of three or more consecutive entities, the first of them is the source of the item to be sent, and the last of them is the final client. The full address of the client is sent only to the one-before-last entity in the chain, together with an index that is unique to the special transaction. The other entities in the chain are supplied only with the transaction index. In cases where there are only three entities, the source does not know the details of the client, and the middle entity does not know the details of the purchased items. However, using this method, the middle entity is still aware of both the source and the client addresses. In order to elevate the anonymity level, in a preferred embodiment of the present invention, another entity is placed between the source and the next-to the client entity, thereby enabling the masking of the identity of the source from the next-to-the client entity.

According to a first aspect of the present invention there is provided a method for making an anonymous computerized commerce transaction involving the delivery of digital merchandise comprising the steps of sending first sensitive information from a first entity to a first intermediate entity; processing said first sensitive information by said first intermediate entity; creating first non sensitive information operable to approve said transaction by said first intermediate entity; sending said first non sensitive information to a third entity operable to perform said transaction; performing said transaction by said third entity, and transferring said digital merchandise to said first entity via a delivering entity comprising information operable to deliver said digital merchandise to said first entity without revealing said first sensitive information to said third entity.

In a preferred embodiment of the present invention, the digital media content comprises digital video media content.

In a preferred embodiment of the present invention, the digital media content comprises digital audio media content.

In a preferred embodiment of the present invention, the digital merchandise comprises digital software.

In a preferred embodiment of the present invention, the method further comprises a second intermediate entity operable to receive second sensitive information from the third entity and operable to process the second sensitive information and operable to create second non sensitive information operable to be sent to the first entity without revealing the second sensitive information the second non sensitive information operable to approve the transaction.

In a preferred embodiment of the present invention, at least two intermediate entities of a substantially similar function to the second intermediate entity are used by the third entity in order to interact with at least two entities substantially similar to the first entity.

In a preferred embodiment of the present invention, at least one of the intermediate entities of a substantially similar function to the second intermediate entity comprises functionality to authenticate the third entity.

In a preferred embodiment of the present invention, the method further comprises performing the functionality of both the first intermediate entity and of the second intermediate entity by one entity.

In a preferred embodiment of the present invention, at least two intermediate entities of a substantially similar function to the first intermediate entity are used by the first entity in order to interact with at least two entities substantially similar to the third entity.

In a preferred embodiment of the present invention, at least one of the intermediate entities of a substantially similar function to the first intermediate entity comprises functionality to authenticate the first entity.

In a preferred embodiment of the present invention, the first sensitive information contains information operable to identify the first entity.

In a preferred embodiment of the present invention, the second sensitive information contains information operable to identify the third entity.

In a preferred embodiment of the present invention, the first sensitive information contains information operable to perform payment for the digital merchandise.

In a preferred embodiment of the present invention, the first intermediate entity comprises functionality to authenticate the first entity.

In a preferred embodiment of the present invention, the second intermediate entity comprises functionality to authenticate the third entity.

In a preferred embodiment of the present invention, the first intermediate entity is operable to perform payment for the digital merchandise.

In a preferred embodiment of the present invention, at least two intermediate entities of a substantially similar function to the first intermediate entity are used by the first entity in order to interact with the third entity.

In a preferred embodiment of the present invention, at least two intermediate entities of a substantially similar function to the second intermediate entity are used by the third entity in order to interact with the first entity.

In a preferred embodiment of the present invention, at least one of the intermediate entities of a substantially similar function to the first intermediate entity comprises functionality to authenticate the first entity.

In a preferred embodiment of the present invention, at least one of the intermediate entities of a substantially similar function to the second intermediate entity comprises functionality to authenticate the third entity.

In a preferred embodiment of the present invention, at least one of the intermediate entities of a substantially similar function to the first intermediate entity is operable to perform payment for the digital merchandise.

In a preferred embodiment of the present invention, at least one of the intermediate entities of a substantially similar function to the first intermediate entity is operable to perform payment for the digital merchandise.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises performing the functionality of both the first intermediate entity and of the third intermediate entity by one entity.

In a preferred embodiment of the present invention, the method further comprises utilizing a coordinating entity, the coordinating entity comprises functionality to store coordinating information operable to direct the first entity to utilize the first intermediate entity in order to perform the transaction with the third entity without the need for the first entity to be aware of the identity of the third entity.

In a preferred embodiment of the present invention, the first entity comprises functionality to store the coordinating information on the coordinating entity.

In a preferred embodiment of the present invention, the third entity comprises functionality to store the coordinating information on the coordinating entity.

In a preferred embodiment of the present invention, the functionality to store the coordinating information on the coordinating entity comprises utilizing a fourth intermediate entity operable to store the coordinating information on the coordinating entity without revealing identifying information of the first entity to the coordinating entity.

In a preferred embodiment of the present invention, the functionality to store the coordinating information on the coordinating entity comprises utilizing a fifth intermediate entity operable to store the coordinating information on the coordinating entity without revealing identifying information of the third entity to the coordinating entity.

In a preferred embodiment of the present invention, the method further comprises utilizing a coordinating entity, the coordinating entity comprises functionality to store coordinating information operable to direct the first entity to utilize the first intermediate entity in order to perform the transaction with the third entity without the need for the first entity to be aware of the identity of the third entity.

In a preferred embodiment of the present invention, the first entity comprises functionality to store the coordinating information on the coordinating entity.

In a preferred embodiment of the present invention, the third entity comprises functionality to store the coordinating information on the coordinating entity.

In a preferred embodiment of the present invention, the functionality to store the coordinating information on the coordinating entity comprises utilizing a fourth intermediate entity operable to store the coordinating information on the coordinating entity without revealing identifying information of the first entity to the coordinating entity.

In a preferred embodiment of the present invention, the functionality to store the coordinating information on the coordinating entity comprises utilizing a fifth intermediate entity operable to store the coordinating information on the coordinating entity without revealing identifying information of the third entity to the coordinating entity.

In a preferred embodiment of the present invention, the information operable to direct the first entity to utilize the first intermediate entity in order to perform the transaction with the third entity without the need for the first entity to be aware of the identity of the third entity comprises information operable to enable the first entity to direct the first intermediate entity to contact the second intermediate entity and to direct the second intermediate entity to perform the following actions: contact the third intermediate entity and to initiate the transaction.

In a preferred embodiment of the present invention, some of the communication of information communicated between two entities in the course of executing and approving the transaction comprise of sending the communication via an entity which is not a party to the communication of information communicated between two entities in the course of executing and approving the transaction.

In a preferred embodiment of the present invention, the entity which is not a party to the communication of information communicated between two entities in the course of executing and approving the transaction is a party to other communication with the two entities thereby eliminating one of the communication channels needed to execute and approve the transaction.

In a preferred embodiment of the present invention, the communication sent via an entity which is not a party to the communication of information communicated between two entities in the course of executing and approving the transaction comprises protection against forgery by a signature thereby preventing the entity which is not a party to the communication of information communicated between two entities in the course of executing and approving the transaction from forging information.

In a preferred embodiment of the present invention, the communication sent via an entity which is not a party to the communication of information communicated between two entities in the course of executing and approving the transaction comprises protection against forgery by encryption thereby preventing the entity which is not a party to the communication of information communicated between two entities in the course of executing and approving the transaction from accessing the communication sent via an entity which is not a party to the communication of information communicated between two entities in the course of executing and approving the transaction.

In a preferred embodiment of the present invention, the technique of sending the communication via an entity which is not a party to the communication of information communicated between two entities in the course of executing and approving the transaction is used to transform sensitive information into non sensitive information by preventing the transfer of sensitive information that would result by direct communication by the two entities.

In a preferred embodiment of the present invention, the eliminated sensitive information whose transfer would result from direct communication by the two entities comprises information about the identity of at least one of the two entities.

In a preferred embodiment of the present invention, the eliminated sensitive information whose transfer would result from direct communication by the two entities comprises information about the address of at least one of the two entities.

In a preferred embodiment of the present invention, the signature is a cryptographic signature.

In a preferred embodiment of the present invention, the digital merchandise comprises encrypted content.

In a preferred embodiment of the present invention, the encrypted content is transferred to the first entity separately from the encrypted content's decryption key.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information the third non sensitive information operable to approve the transaction and the method further comprises performing the functionality of at least two of the following by one entity: of the first intermediate entity, of the second intermediate entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises performing the functionality of both the first intermediate entity and of the coordinating entity by one entity.

In a preferred embodiment of the present invention, the method further comprises performing the functionality of at least two of the following by one entity: of the first intermediate entity, of the fourth intermediate entity and of the coordinating entity.

In a preferred embodiment of the present invention, the method further comprises performing the functionality of at least two of the following by one entity: of the first intermediate entity, of the second intermediate entity and of the coordinating entity.

In a preferred embodiment of the present invention, the method further comprises performing the functionality of at least two of the following by one entity: of the first intermediate entity, of the second intermediate entity, of the fourth intermediate and of the coordinating entity.

In a preferred embodiment of the present invention, the method further comprises performing the functionality of at least two of the following by one entity: of the first intermediate entity, of the second intermediate entity, of the fifth intermediate and of the coordinating entity.

In a preferred embodiment of the present invention, the third entity comprises functionality to store the coordinating information on the coordinating entity and the functionality to store the coordinating information on the coordinating entity comprises utilizing a fifth intermediate entity operable to store the coordinating information on the coordinating entity without revealing identifying information of the third entity to the coordinating entity and the method further comprises performing the functionality of at least two of the following by one entity: of the first intermediate entity, of the second intermediate entity, of the fourth intermediate, of the fifth intermediate and of the coordinating entity.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the coordinating entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the second intermediate entity, of the coordinating entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the fourth intermediate entity, of the coordinating entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the second intermediate entity, of the fourth intermediate entity, of the coordinating entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the second intermediate entity, of the fifth intermediate entity, of the coordinating entity and of the third intermediate entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the third entity comprises functionality to store the coordinating information on the coordinating entity and the functionality to store the coordinating information on the coordinating entity comprises utilizing a fifth intermediate entity operable to store the coordinating information on the coordinating entity without revealing identifying information of the third entity to the coordinating entity and the method further comprises a third intermediate entity operable to receive third sensitive information from the third entity and operable to process the second sensitive information and operable to create third non sensitive information operable to be sent to a fourth entity without revealing the third sensitive information, the third non sensitive information operable to approve the transaction and the method further comprises performing the functionality of at least two of the following by one entity: of the first intermediate entity, of the second intermediate entity, of the third intermediate entity, of the fourth intermediate, of the fifth intermediate and of the coordinating entity.

In a preferred embodiment of the present invention, at least two intermediate entities of a substantially similar function to the third intermediate entity are used by the third entity in order to interact with at least two entities substantially similar to the fourth entity.

In a preferred embodiment of the present invention, at least two intermediate entities of a substantially similar function to the third intermediate entity are used by the third entity in order to interact with the fourth entity.

In a preferred embodiment of the present invention, at least one of the intermediate entities of a substantially similar function to the third intermediate entity comprises functionality to authenticate the third entity.

In a preferred embodiment of the present invention, at least one of the intermediate entities of a substantially similar function to the third intermediate entity comprises functionality to authenticate the third entity.

In a preferred embodiment of the present invention, the third sensitive information contains information operable to identify the third entity.

In a preferred embodiment of the present invention, the method further comprising communicating at least some of the information communicated in the course of approving and executing the transaction via a least one intermediate entity.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a system for anonymous commerce, constructed and operative in accordance with a preferred embodiment of the present invention;

FIG. 2 is an illustration of a system, substantially similar to the system of FIG. 1, constructed and operative in accordance with a preferred embodiment of the present invention, where another anonymous delivery service is added to the system;

FIG. 3 is an illustration of a system, substantially similar to the system of FIG. 1, and FIG. 2, constructed and operative in accordance with a preferred embodiment of the present invention, where another anonymity service is introduced in the monetary transaction route;

FIG. 4 illustrates a system, similar to the systems in FIGS. 1-3, that is used for anonymous delivery of encrypted digital content;

FIG. 5 illustrates a method, operative in accordance with a preferred embodiment of the present invention, that allows to establish anonymous connection between the vendor and a client, and

FIG. 6 illustrates a method, operative in accordance with a preferred embodiment of the present invention, that further enhance the anonymity level by introducing an acquirer buffer.

### DETAILED DESCRIPTION OF PREFERRED EMBODIMENTS

The present invention seeks to provide a system and a method for anonymous transactions. For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how at least two forms of the invention may be embodied in practice.

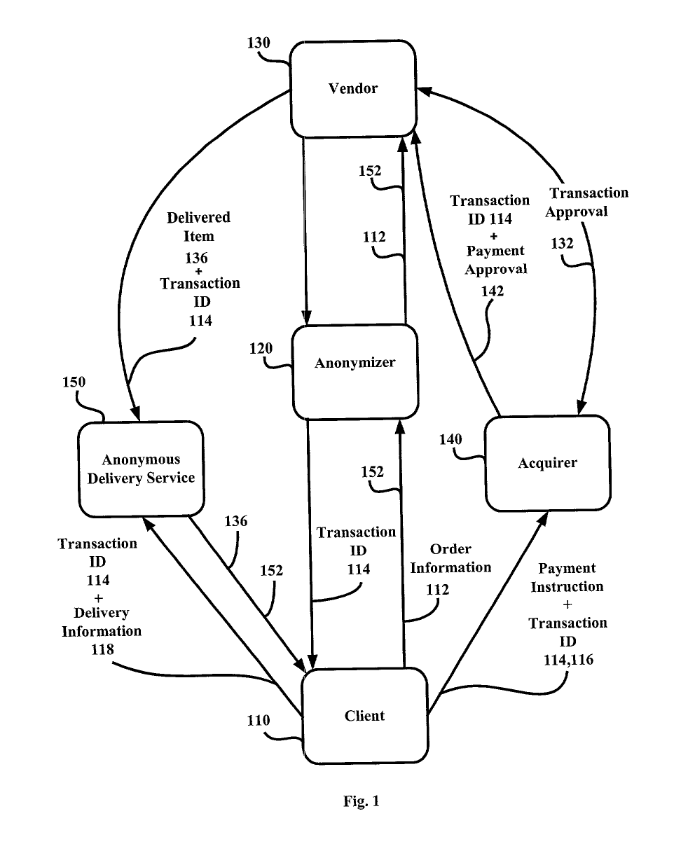

Turning now to FIG. 1, there is illustrated a simplified block conceptual illustration of a system for anonymous commerce, constructed and operative in accordance with a preferred embodiment of the present invention, in which a client 110 sends a request to a vendor 130 that contains order information 112. In a preferred embodiment of the present invention, the client utilizes a standard anonymizing service 120, which is preferably provided by at least two internet sites in order to mask the client internet protocol (IP) address from the vendor, thereby further enhancing the level of anonymity. The client 110 in turn receives from the vendor 130 the transaction identification number (ID) 114 via the same route. This transaction number is preferably a globally unique variable that is shared between various entities in the system, and may be created by any of the entities or by utilizing at least two of them, preferably being created by the vendor. The client sends the payment instruction (PI) 116, which may include the amount to be paid, terms of payment, relevant details of the vendor etc., preferably encrypted and certificated, together with the transaction ID 114, to the acquirer 140, which approves and guarantees the transaction (e.g., by performing a credit-card clearance). The acquirer then sends the vendor 130 the transaction ID 114 together with payment approval 142 to the vendor 130, thereby allowing the vendor 130 to approve the transaction 132. The transaction approval may be performed between the vendor 130 and the acquirer 140, the vendor and a 3^{rd} party, or by another known method. The client also sends his address and/or other delivery information 118 to the anonymous delivery service 150, together with the transaction ID 114, and in turn receives the ID 152 of the anonymous delivery service 150, which he sends to the vendor 130. After the approval of the transaction, the vendor sends the virtual and/or physical purchased item 136 to the anonymous delivery service 150, together with the transaction ID 114. The anonymous delivery service associates the transaction ID to the client address and/or other delivery information and sends the item 132 to the client 110.

In a preferred embodiment of the present invention, all the operations are automatically preformed by computer programs in the various entities.

In order to illustrate the above method, consider the following scenario: the client, Mrs. Jane Doe, wishes to buy astronomical software from the Internet site astrodoe.com. She uses her web browser in order to connect to the anonymization site anonydoe.net, and keep browsing with her IP masked by the site software. She orders the software and a software client on her computer gets the corresponding transaction ID 114 from the vendor via the anonimyzer. The software client then sends the payment instruction (PI), (e.g., credit-card details, the amount of money, the number of payments etc . . . ), together with the transaction ID to the acquirer 140, and delivery information (e.g., physical and/or e-mail address and/or IP address) to the anonymous delivery service. The acquirer confirms that the credit card is valid, and preferably also authenticates the client, in order to reduce the chances for fraud. The acquirer then sends the vendor the approval to the transaction 142, using the transaction ID 114 in order to identify the transaction. The vendor then sends the acquirer the approval for the transaction, and sends the software, wrapped in a manner that does not conceal its content to the anonymous delivery service 150, together with the corresponding transaction ID. The anonymous delivery service 150 completes the transaction by sending the software to Mrs. Jane Doe. Using this methods, none of the entities involved in the transaction is exposed both to the content of the purchased item and the identity of the customer.

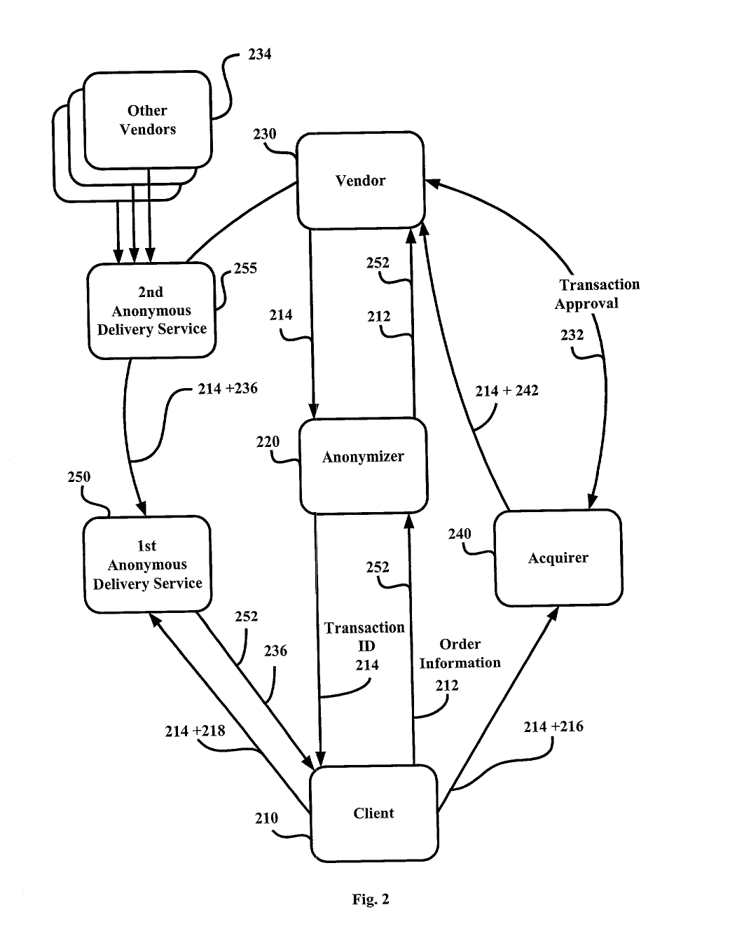

Using the above method, the anonymous delivery service 150 still has transport information, i.e., the fact that a certain client bought something from a certain vendor. This problem can be solved by introducing another anonymous delivery service: turning now to FIG. 2, there is illustrated a method, substantially similar to the method of FIG. 1, constructed and operative in accordance with a preferred embodiment of the present invention, where another anonymous delivery service 255 is added to the system. (for brevity, the first digit of the numbers in the drawing is equal to the figure number, while the other digits remain consistent between the substantially similar entities in the various drawing). Here, again, the client 210 uses the anonymizer 220 to send a request to the vendor 230 that contained the order information 212 and gets back the transaction ID 214. The client sends the payment instruction (PI) 216, together with the transaction ID 214, to the acquirer 240. The acquirer then sends the transaction ID 214 together with payment approval 242 to the vendor 230. The client also sends his address and/or other delivery information 218 to the first anonymous delivery service 250, together with the transaction ID 214 and gets back the ID 252 of the first anonymous delivery service 250, which he sends to the vendor 230. After the approval of the transaction, the vendor sends the virtual and/or physical purchased item 236 to the second anonymous delivery service 250, together with the transaction ID 214. The second anonymous delivery service 255 associates the transaction ID 214 with the ID 252 of the first anonymous delivery service 250, and sends the purchases item 232, together with the transaction ID 214 to the first anonymous delivery service 250. The first anonymous delivery service associates the transaction ID to the client address and/or other delivery information and sends the item 232 to the client 210. Information regarding the identity of the vendor is known only to the second anonymous delivery service 255, which receives items from at least two vendors 234, while information regarding the identity of the client is known only to anonymous delivery service 250.

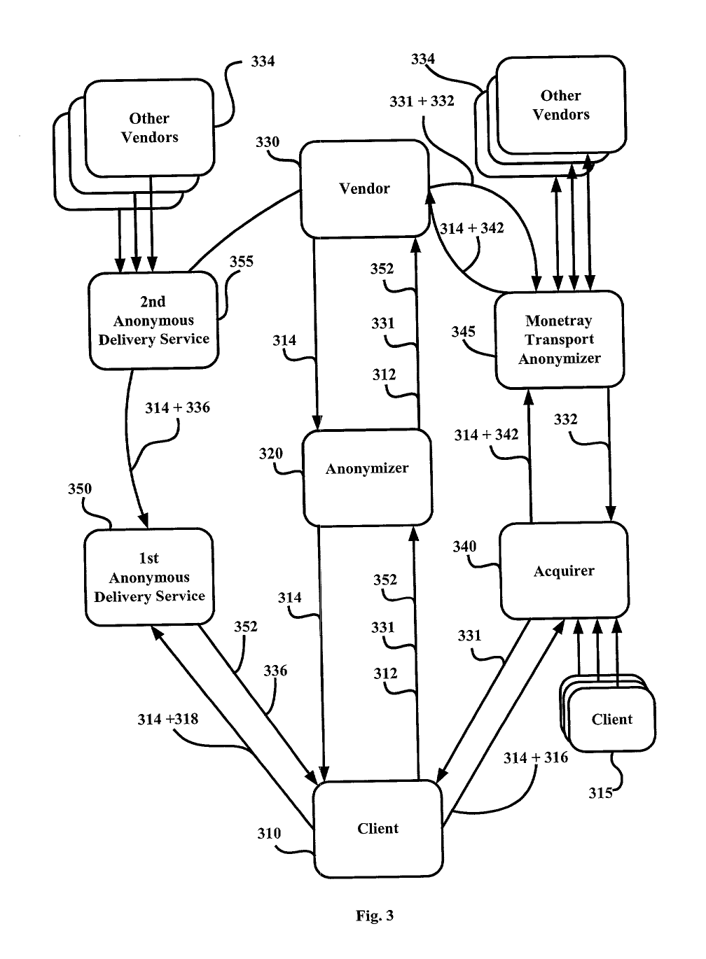

The above scheme for obscuring the transport details may also be used in order to obscure the details of the monetary transaction: turning now to FIG. 3, there is illustrated a method, substantially similar to the methods of FIGS. 1 and 2, constructed and operative in accordance with a preferred embodiment of the present invention, where another anonymity service 345 is introduced in order to mask some of the details of the monetary transaction. Information regarding the identity of the vendor is known only to the anonymous service 345, that preferably form connections with at least two vendors 334, while information regarding the identity of the client is known only to the acquirer 340, which preferably form connections with at least two clients 315. Here, again, the client 310 uses the anonymizer 320 to send a request to the vendor 330 that contained the order information 312 and get back the transaction ID 314. The client sends the payment instruction (PI) 316, together with the transaction ID 314, to the acquirer 340. The acquirer then sends an acquirer ID 331 to the client 310, who sends the acquirer ID 331 to the vendor. The vendor then sends the acquirer ID 331 to the monetary transport anonymizer 345. The acquirer sends the transaction ID 314 together with payment approval 342 to the monetary transport anonymizer 345. The client 310 also sends his address and/or other delivery information 318 to the first anonymous delivery service 350, together with the transaction ID 314 and gets back the ID 352 of the first anonymous delivery service 350, which he sends to the vendor 330. After the approval of the transaction, the vendor sends the digital and/or physical purchased item 336 to the second anonymous delivery service 355, together with the transaction ID 314. The second anonymous delivery service associates the transaction ID 314 to the ID 352 of the first anonymous delivery service 350, and sends the purchases item 336, together with the transaction ID 314 to the first anonymous delivery service 350. The first anonymous delivery service associates the transaction ID to the client address and/or other delivery information and sends the item 332 to the client 310.

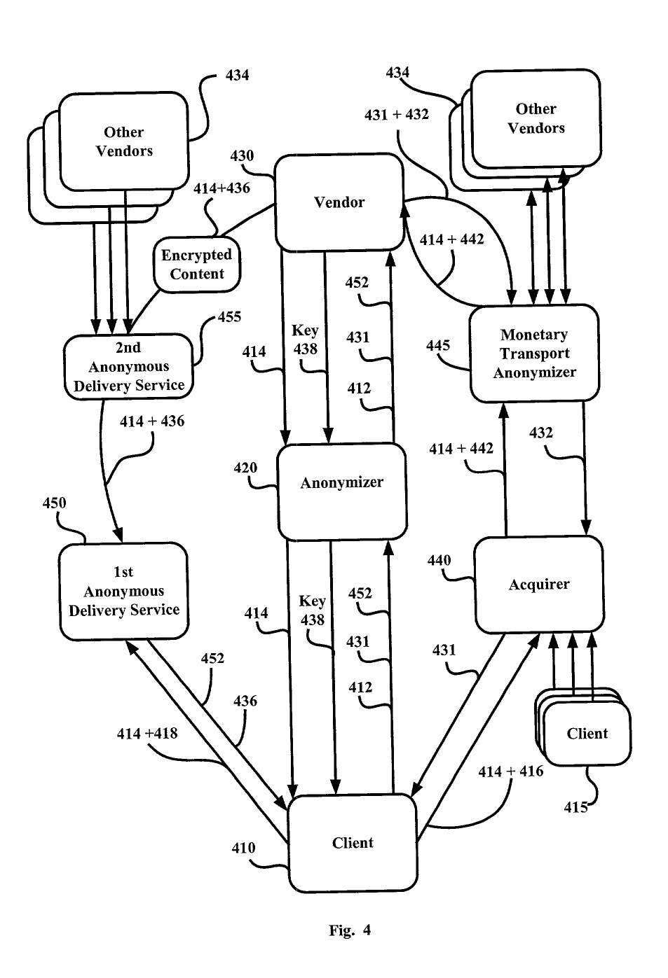

The anonymous delivery service described above can be used for the distribution of both physical and digital content. For the anonymous delivery of physical content, the vendor should wrap the items in a case or an envelope that may contain the transaction ID, or the transaction ID may be linked to the physical content in some other way. The anonymous delivery service may transform this ID (or part of it) to the address or to the delivery information of the client. For anonymous delivery of digital content, the role of the envelope may be taken by encryption and/or other means. The key for the decryption of the content may be sent to the client using the same anonymous route that the client used in order to send the vendor his order information and transaction ID. FIG. 4 illustrates a method, constructed and operative in accordance with a preferred embodiment of the present invention, which is substantially similar to the one described in FIGS. 1-3, but the acquirer now sends the client an encrypted digital content: The client 410 uses the anonymizer 420 to send a request to the vendor 430 that contained the order information 412 and get back the transaction ID 414 and an encryption key 438. The client sends the payment instruction (PI) 416, together with the transaction ID 414, to the acquirer 440. The acquirer then sends an acquirer ID 431 to the client 410, who sends the acquirer ID 431 to the vendor. The vendor then sends the acquirer ID 431 to the monetary transport anonimizer 445. The acquirer sends the transaction ID 414 together with payment approval 442 to the monetary transport anonymizer 445. The client 410 also sends his delivery information 418 to the first anonymous delivery service 450, together with the transaction ID 414 and gets back the ID 452 of the first anonymous delivery service 450, which the client 410 sends to the vendor 430. After the approval of the transaction, the vendor sends the purchased digital item 436, encrypted using the key 438, to the second anonymous delivery service 450, together with the transaction ID 414. The second anonymous delivery service associates the transaction ID 414 to the ID 452 of first anonymous delivery service 450, and sends the purchases item 432, together with the transaction ID 414 to the first anonymous delivery service 450. The first anonymous delivery service associates the transaction ID to the client address and/or other delivery information and sends the item 432 to the client 410, which decrypt the encrypted content 436 using the key 438.

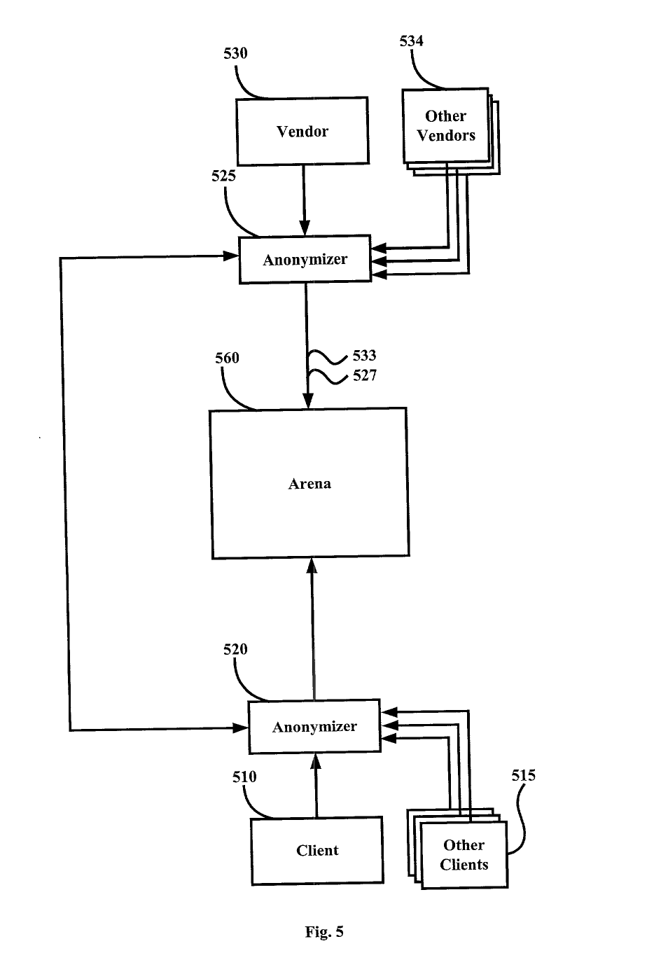

Turning now to FIG. 5, there is illustrated a method, operative in accordance with a preferred embodiment of the present invention, that allows to establish anonymous connection between the vendor and a client, in a manner that assures that no single entity is exposed to the identity of both sides of the transaction: The vendor 530 publish the goods it offers 533 in the arena 560 using the anonimizer 525, which is preferably also connected to other vendors 534. The goods are published together with the address 527 of the anonymizer 525 (the address may be its Internet protocol (IP) address). The client 510 uses the anonimizer 520, which is preferably connected to other clients 515, in order to look for items that are offered in the arena 560. If the client is interested in buying the goods 533, it uses the address 527 in order to establish a connection with vendor 530 via the anonymizer 525. Using this method, no single entity is aware of the identity of the both sides of the transaction.

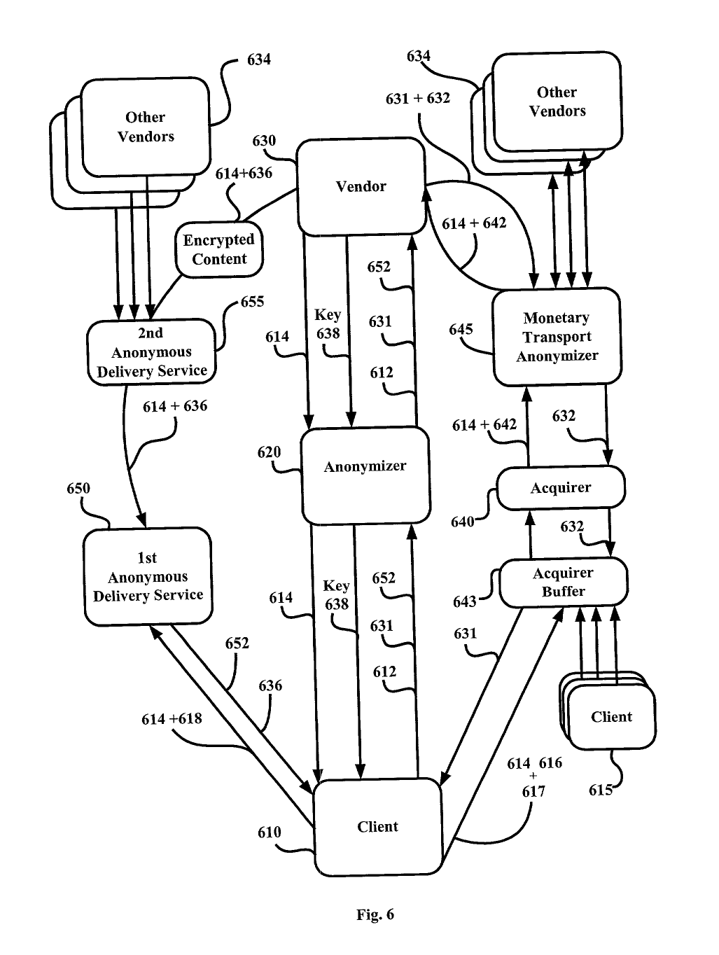

Reference is now made to FIG. 6, which illustrates a method, operative in accordance with a preferred embodiment of the present invention, that further enhance the anonymity level by introducing an acquirer buffer, to which at least two clients are connected, and is used to mask some of the information regarding the clients (e.g., its Internet protocol (IP) address): the client 610 uses the anonymizer 620 to send a request to the vendor 630 that contained the order information 612 and get back the transaction ID 614. The client sends the payment instruction (PI) 616, together with the transaction ID 614 to the acquirer buffer 643. The client may also send the acquirer buffer 643 additional information 617 that may be used for authentication or as a proof that the client is eligible to perform the transaction. The acquirer buffer 643 sends the payment instruction (PI) 616 together with the transaction ID 614 and preferably also the additional information 617 to the acquirer 640. The acquirer checks that the payment instruction (PI) 616 is valid and then sends an acquirer ID 631 to the client 610, who sends the acquirer ID 631 to the vendor. The vendor then sends the acquirer ID 631 to the monetary transport anonimizer 645. The acquirer sends the transaction ID 614 together with payment approval 642 to the monetary transport anonymizer 645, which then sends the transaction ID 614 together with payment approval 642 to the vendor 630. The client 610 also sends its delivery information 618 to the first anonymous delivery service 650, together with the transaction ID 614, and gets back the ID 652 of the first anonymous delivery service 650, which the client 610 sends to the vendor 630. After the approval of the transaction, the vendor sends the purchased digital item 636, encrypted with the key 638, to the second anonymous delivery service 650, together with the transaction ID 614. The second anonymous delivery service associates the transaction ID 614 to the ID 652 of first anonymous delivery service 650, and sends the purchases item 632, together with the transaction ID 614 to the first anonymous delivery service 650. The first anonymous delivery service associates the transaction ID to the client address and/or other delivery information and sends the item 632 to the client 610, which decrypt the encrypted content 636 using the key 638.

In a preferred embodiment of the present invention, a coordinating entity exist to enable a client to chose a vendor without being aware of the identity of the vendor, the vendor is registered, preferably via an anonymizer into the coordinating entity's database, the information registered is preferably validated or otherwise vouched for, afterward (or, in case of a similarity registered client, possibly beforehand) the client contacts the coordinating entity and ask for a vendor which can supply the desired merchandise to the client in agreeable terms, preferably selecting the most suitable vendor, the coordinating entity supplies the client with the needed details to contact the vendor without revealing who is the vendor (e.g. the vendor's anonimizer's address).

It is appreciated that one or more steps of any of the methods described herein may be implemented in a different order than that shown, while not departing from the spirit and scope of the invention.

While the present invention may or may not have been described with reference to specific hardware or software, the present invention has been described in a manner sufficient to enable persons having ordinary skill in the art to readily adapt commercially available hardware and software as may be needed to reduce any of the embodiments of the present invention to practice without undue experimentation and using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for making an anonymous computerized commerce transaction involving the delivery of digital merchandise comprising:
sending first sensitive information from a first entity to a first intermediate entity;
processing said first sensitive information at said first intermediate entity;
creating first non-sensitive information operable to approve said transaction by said first intermediate entity;
sending said first non-sensitive information to a third entity operable to perform said transaction;
performing said transaction at said third entity, and
transferring said digital merchandise to said first entity via a delivering entity comprising information operable to deliver said digital merchandise to said first entity without revealing said first sensitive information to said third entity.

2. A method according to claim 1 wherein said digital merchandise comprises digital media content.

3. A method according to claim 2 wherein said digital media content comprises digital video media content.

4. A method according to claim 2 wherein said digital media content comprises digital audio media content.

5. A method according to claim 1 wherein said digital merchandise comprises digital software.

6. A method according to claim 1 wherein said method further comprises a second intermediate entity operable to receive second sensitive information from said third entity and operable to process said second sensitive information and operable to create second non sensitive information operable to be sent to said first entity without revealing said second sensitive information said second non sensitive information operable to approve said transaction.

7. A method according to claim 6 wherein at least two intermediate entities of a substantially similar function to said second intermediate entity are used by said third entity in order to interact with at least two entities substantially similar to said first entity.

8. A method according to claim 7 wherein at least one of said intermediate entities of a substantially similar function to said second intermediate entity comprises functionality to authenticate said third entity.

9. A method according to claim 6 wherein said method further comprises performing the functionality of both said first intermediate entity and of said second intermediate entity by one entity.

10. A method according to claim 1 wherein at least two intermediate entities of a substantially similar function to said first intermediate entity are used by said first entity in order to interact with at least two entities substantially similar to said third entity.

11. A method according to claim 10 wherein at least one of said intermediate entities of a substantially similar function to said first intermediate entity comprises functionality to authenticate said first entity.

12. A method according to claim 1 wherein said first sensitive information contains information operable to identify said first entity.

13. A method according to claim 6 wherein said second sensitive information contains information operable to identify said third entity.

14. A method according to claim 1 wherein said first sensitive information contains information operable to perform payment for said digital merchandise.

15. A method according to claim 1 wherein said first intermediate entity comprises functionality to authenticate said first entity.

16. A method according to claim 6 wherein said second intermediate entity comprises functionality to authenticate said third entity.

17. A method according to claim 1 wherein said first intermediate entity is operable to perform payment for said digital merchandise.

18. A method according to claim 1 wherein at least two intermediate entities of a substantially similar function to said first intermediate entity are used by said first entity in order to interact with said third entity.

19. A method according to claim 6 wherein at least two intermediate entities of a substantially similar function to said second intermediate entity are used by said third entity in order to interact with said first entity.

20. A method according to claim 18 wherein at least one of said intermediate entities of a substantially similar function to said first intermediate entity comprises functionality to authenticate said first entity.

21. A method according to claim 19 wherein at least one of said intermediate entities of a substantially similar function to said second intermediate entity comprises functionality to authenticate said third entity.

22. A method according to claim 10 wherein at least one of said intermediate entities of a substantially similar function to said first intermediate entity is operable to perform payment for said digital merchandise.

23. A method according to claim 19 wherein at least one of said intermediate entities of a substantially similar function to said first intermediate entity is operable to perform payment for said digital merchandise.

24. A method according to claim 1 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction.

25. A method according to claim 24 wherein at least two intermediate entities of a substantially similar function to said third intermediate entity are used by said third entity in order to interact with at least two entities substantially similar to said fourth entity.

26. A method according to claim 24 wherein at least two intermediate entities of a substantially similar function to said third intermediate entity are used by said third entity in order to interact with said fourth entity.

27. A method according to claim 25 wherein at least one of said intermediate entities of a substantially similar function to said third intermediate entity comprises functionality to authenticate said third entity.

28. A method according to claim 26 wherein at least one of said intermediate entities of a substantially similar function to said third intermediate entity comprises functionality to authenticate said third entity.

29. A method according to claim 24 wherein said third sensitive information contains information operable to identify said third entity.

30. A method according to claim 24 wherein said method further comprises performing the functionality of both said first intermediate entity and of said third intermediate entity by one entity.

31. A method according to claim 1 wherein said method further comprises utilizing a coordinating entity, said coordinating entity comprises functionality to store coordinating information operable to direct said first entity to utilize said first intermediate entity in order to perform said transaction with said third entity without the need for said first entity to be aware of the identity of said third entity.

32. A method according to claim 31 wherein said first entity comprises functionality to store said coordinating information on said coordinating entity.

33. A method according to claim 31 wherein said third entity comprises functionality to store said coordinating information on said coordinating entity.

34. A method according to claim 32 wherein said functionality to store said coordinating information on said coordinating entity comprises utilizing a fourth intermediate entity operable to store said coordinating information on said coordinating entity without revealing identifying information of said first entity to said coordinating entity.

35. A method according to claim 33 wherein said functionality to store said coordinating information on said coordinating entity comprises utilizing a fifth intermediate entity operable to store said coordinating information on said coordinating entity without revealing identifying information of said third entity to said coordinating entity.

36. A method according to claim 6 wherein said method further comprises utilizing a coordinating entity, said coordinating entity comprises functionality to store coordinating information operable to direct said first entity to utilize said first intermediate entity in order to perform said transaction with said third entity without the need for said first entity to be aware of the identity of said third entity.

37. A method according to claim 36 wherein said first entity comprises functionality to store said coordinating information on said coordinating entity.

38. A method according to claim 36 wherein said third entity comprises functionality to store said coordinating information on said coordinating entity.

39. A method according to claim 37 wherein said functionality to store said coordinating information on said coordinating entity comprises utilizing a fourth intermediate entity operable to store said coordinating information on said coordinating entity without revealing identifying information of said first entity to said coordinating entity.

40. A method according to claim 38 wherein said functionality to store said coordinating information on said coordinating entity comprises utilizing a fifth intermediate entity operable to store said coordinating information on said coordinating entity without revealing identifying information of said third entity to said coordinating entity.

41. A method according to claim 36 wherein said information operable to direct said first entity to utilize said first intermediate entity in order to perform said transaction with said third entity without the need for said first entity to be aware of the identity of said third entity comprises information operable to enable said first entity to direct said first intermediate entity to contact said second intermediate entity and to direct said second intermediate entity to perform the following actions: contact said third intermediate entity and to initiate said transaction.

42. A method according to claim 1 wherein some of the communication of information communicated between two entities in the course of executing and approving said transaction comprise of sending said communication via an entity which is not a party to said communication of information communicated between two entities in the course of executing and approving said transaction.

43. A method according to claim 42 wherein said entity which is not a party to said communication of information communicated between two entities in the course of executing and approving said transaction is a party to other communication with said two entities thereby eliminating one of the communication channels needed to execute and approve said transaction.

44. A method according to claim 42 wherein said communication sent via an entity which is not a party to said communication of information communicated between two entities in the course of executing and approving said transaction comprises protection against forgery by a signature thereby preventing said entity which is not a party to said communication of information communicated between two entities in the course of executing and approving said transaction from forging information.

45. A method according to claim 42 wherein said communication sent via an entity which is not a party to said communication of information communicated between two entities in the course of executing and approving said transaction comprises protection against forgery by encryption thereby preventing said entity which is not a party to said communication of information communicated between two entities in the course of executing and approving said transaction from accessing said communication sent via an entity which is not a party to said communication of information communicated between two entities in the course of executing and approving said transaction.

46. A method according to claim 42 wherein said technique of sending said communication via an entity which is not a party to said communication of information communicated between two entities in the course of executing and approving said transaction is used to transform sensitive information into non sensitive information by preventing the transfer of sensitive information that would result by direct communication by said two entities.

47. A method according to claim 46 wherein said eliminated sensitive information whose transfer would result from direct communication by said two entities comprises information about the identity of at least one of said two entities.

48. A method according to claim 46 wherein said eliminated sensitive information whose transfer would result from direct communication by said two entities comprises information about the address of at least one of said two entities.

49. A method according to claim 44 wherein said signature is a cryptographic signature.

50. A method according to claim 1 wherein said digital merchandise comprises encrypted content.

51. A method according to claim 50 wherein said encrypted content is transferred to said first entity separately from said encrypted content's decryption key.

52. A method according to claim 6 wherein said method further comprises a third intermediate entity operable to receive third sensitive information from said third entity and operable to process said second sensitive information and operable to create third non sensitive information operable to be sent to a fourth entity without revealing said third sensitive information said third non sensitive information operable to approve said transaction and wherein said method further comprises performing the functionality of at least two of the following by one entity: of said first intermediate entity, of said second intermediate entity and of said third intermediate entity.

53. A method according to claim 52 wherein at least two intermediate entities of a substantially similar function to said third intermediate entity are used by said third entity in order to interact with at least two entities substantially similar to said fourth entity.

54. A method according to claim 52 wherein at least two intermediate entities of a substantially similar function to said third intermediate entity are used by said third entity in order to interact with said fourth entity.

55. A method according to claim 53 wherein at least one of said intermediate entities of a substantially similar function to said third intermediate entity comprises functionality to authenticate said third entity.

56. A method according to claim 54 wherein at least one of said intermediate entities of a substantially similar function to said third intermediate entity comprises functionality to authenticate said third entity.

57. A method according to claim 52 wherein said third sensitive information contains information operable to identify said third entity.

58. A method according to claim 31 wherein said method farther comprises performing the functionality of both said first intermediate entity and of said coordinating entity by one entity.

59. A method according to claim 34 wherein said method further comprises performing the functionality of at least two of the following by one entity: of said first intermediate entity, of said fourth intermediate entity and of said coordinating entity.

60. A method according to claim 36 wherein said method farther comprises performing the functionality of at least two of the following by one entity: of said first intermediate entity, of said second intermediate entity and of said coordinating entity.

61. A method according to claim 39 wherein said method further comprises performing the functionality of at least two of the following by one entity: of said first intermediate entity, of said second intermediate entity, of said fourth intermediate and of said coordinating entity.

62. A method according to claim 40 wherein said method farther comprises performing the functionality of at least two of the following by one entity: of said first intermediate entity, of said second intermediate entity, of said fifth intermediate and of said coordinating entity.

63. A method according to claim 39 wherein said third entity comprises functionality to store said coordinating information on said coordinating entity and wherein said functionality to store said coordinating information on said coordinating entity comprises utilizing a fifth intermediate entity operable to store said coordinating information on said coordinating entity without revealing identifying information of said third entity to said coordinating entity and wherein said method further comprises performing the functionality of at least two of the following by one entity: of said first intermediate entity, of said second intermediate entity, of said fourth intermediate, of said fifth intermediate and of said coordinating entity.

64. A method according to claim 31 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said coordinating entity and of said third intermediate entity.

65. A method according to claim 64 wherein at least two intermediate entities of a substantially similar function to said third intermediate entity are used by said third entity in order to interact with at least two entities substantially similar to said fourth entity.

66. A method according to claim 64 wherein at least two intermediate entities of a substantially similar function to said third intermediate entity are used by said third entity in order to interact with said fourth entity.

67. A method according to claim 65 wherein at least one of said intermediate entities of a substantially similar function to said third intermediate entity comprises functionality to authenticate said third entity.

68. A method according to claim 66 wherein at least one of said intermediate entities of a substantially similar function to said third intermediate entity comprises functionality to authenticate said third entity.

69. A method according to claim 64 wherein said third sensitive information contains information operable to identify said third entity.

70. A method according to claim 36 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said second intermediate entity, of said coordinating entity and of said third intermediate entity.

71. A method according to claim 70 wherein at least two intermediate entities of a substantially similar function to said third intermediate entity are used by said third entity in order to interact with at least two entities substantially similar to said fourth entity.

72. A method according to claim 70 wherein at least two intermediate entities of a substantially similar function to said third intermediate entity are used by said third entity in order to interact with said fourth entity.

73. A method according to claim 71 wherein at least one of said intermediate entities of a substantially similar function to said third intermediate entity comprises functionality to authenticate said third entity.

74. A method according to claim 72 wherein at least one of said intermediate entities of a substantially similar function to said third intermediate entity comprises functionality to authenticate said third entity.

75. A method according to claim 70 wherein said third sensitive information contains information operable to identify said third entity.

76. A method according to claim 34 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said fourth intermediate entity, of said coordinating entity and of said third intermediate entity.

77. A method according to claim 76 wherein at least two intermediate entities of a substantially similar function to said third intermediate entity are used by said third entity in order to interact with at least two entities substantially similar to said fourth entity.

78. A method according to claim 76 wherein at least two intermediate entities of a substantially similar function to said third intermediate entity are used by said third entity in order to interact with said fourth entity.

79. A method according to claim 77 wherein at least one of said intermediate entities of a substantially similar function to said third intermediate entity comprises functionality to authenticate said third entity.

80. A method according to claim 78 wherein at least one of said intermediate entities of a substantially similar function to said third intermediate entity comprises functionality to authenticate said third entity.

81. A method according to claim 76 wherein said third sensitive information contains information operable to identify said third entity.

82. A method according to claim 39 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said second intermediate entity, of said fourth intermediate entity, of said coordinating entity and of said third intermediate entity.

83. A method according to claim 82 wherein at least two intermediate entities of a substantially similar function to said third intermediate entity are used by said third entity in order to interact with at least two entities substantially similar to said fourth entity.

84. A method according to claim 82 wherein at least two intermediate entities of a substantially similar function to said third intermediate entity are used by said third entity in order to interact with said fourth entity.

85. A method according to claim 83 wherein at least one of said intermediate entities of a substantially similar function to said third intermediate entity comprises functionality to authenticate said third entity.

86. A method according to claim 84 wherein at least one of said intermediate entities of a substantially similar function to said third intermediate entity comprises functionality to authenticate said third entity.

87. A method according to claim 82 wherein said third sensitive information contains information operable to identify said third entity.

88. A method according to claim 40 wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said second intermediate entity, of said fifth intermediate entity, of said coordinating entity and of said third intermediate entity.

89. A method according to claim 88 wherein at least two intermediate entities of a substantially similar function to said third intermediate entity are used by said third entity in order to interact with at least two entities substantially similar to said fourth entity.

90. A method according to claim 88 wherein at least two intermediate entities of a substantially similar function to said third intermediate entity are used by said third entity in order to interact with said fourth entity.

91. A method according to claim 89 wherein at least one of said intermediate entities of a substantially similar function to said third intermediate entity comprises functionality to authenticate said third entity.

92. A method according to claim 90 wherein at least one of said intermediate entities of a substantially similar function to said third intermediate entity comprises functionality to authenticate said third entity.

93. A method according to claim 88 wherein said third sensitive information contains information operable to identify said third entity.

94. A method according to claim 39 wherein said third entity comprises functionality to store said coordinating information on said coordinating entity and wherein said functionality to store said coordinating information on said coordinating entity comprises utilizing a fifth intermediate entity operable to store said coordinating information on said coordinating entity without revealing identifying information of said third entity to said coordinating entity and wherein said method further comprises a third intermediate entity operable to receive third sensitive information from said third entity and operable to process said second sensitive information and operable to create third non sensitive information operable to be sent to a fourth entity without revealing said third sensitive information, said third non sensitive information operable to approve said transaction and wherein said method further comprises performing the functionality of at least two of the following by one entity: of said first intermediate entity, of said second intermediate entity, of said third intermediate entity, of said fourth intermediate, of said fifth intermediate and of said coordinating entity.

95. A method according to claim 94 wherein at least two intermediate entities of a substantially similar function to said third intermediate entity are used by said third entity in order to interact with at least two entities substantially similar to said fourth entity.

96. A method according to claim 94 wherein at least two intermediate entities of a substantially similar function to said third intermediate entity are used by said third entity in order to interact with said fourth entity.

97. A method according to claim 95 wherein at least one of said intermediate entities of a substantially similar function to said third intermediate entity comprises functionality to authenticate said third entity.

98. A method according to claim 96 wherein at least one of said intermediate entities of a substantially similar function to said third intermediate entity comprises functionality to authenticate said third entity.

99. A method according to claim 94 wherein said third sensitive information contains information operable to identify said third entity.

100. A method according to claim 1 further comprising communicating at least some of the information communicated in the course of approving and executing said transaction via a least one intermediate entity.
